(19) United States
(12) Patent Application Publication
(10) Pub. No.: US 2015/0051915 A1
(43) Pub. Date: Feb. 19, 2015

(54) SYSTEMS AND METHODS FOR ALLOCATING PAYMENTS ACROSS MULTIPLE HEALTHCARE ACCOUNTS

(71) Applicant: MCKESSON FINANCIAL HOLDINGS, Hamilton (BM)

(72) Inventor: Matthew E. Moore, Aurora, IL (US)

(73) Assignee: MCKESSON FINANCIAL HOLDINGS, Hamilton (BM)

(21) Appl. No.: 13/966,799

(22) Filed: Aug. 14, 2013

(51) Int. Cl. G06F 19/00; G06Q 20/38; G06Q 50/22

(52) U.S. Cl. CPC G06F 19/328; G06Q 50/22; G06Q 20/38
USPC 705/2

(57) ABSTRACT

Systems and methods are provided for facilitating account payment posting transactions. A computer-implemented method may include receiving, from a computer associated with a healthcare provider, a healthcare payment transaction for a patient, wherein the healthcare payment transaction comprises an identifier for a guarantor of the patient and a total payment amount. The method may also include determining, based at least in part on the guarantor identifier, one or more open medical accounts for the guarantor, the one or more open medical accounts having respective outstanding balances. Furthermore, the method may include comparing the total payment amount with the respective outstanding balances and generating, based at least in part on the comparison, an account payment posting transaction. The account payment posting transaction may indicate respective amounts, of the total payment amount, to be allocated to the one or more open medical accounts. Additionally, the method may include transmitting the account payment posting transaction to the computer associated with the healthcare provider

### TECHNICAL FIELD

Aspects of the disclosure relate generally to healthcare transactions, and more particularly, to systems and methods for allocating payments across multiple healthcare accounts.

### BACKGROUND

In order to collect payment for medical claims, certain healthcare providers may issue guarantor consolidated patient statements to patients. A guarantor consolidated patient statement may be a single statement that includes a balance due for the insurance guarantor's and his/her dependent's medical accounts as a whole. For example, a family may include a husband, a wife, and two children. The husband may be the insurance guarantor while the wife and two children may be his dependents. As such, the guarantor consolidated patient statement may be issued for the husband's account and may include one or more balances due for his dependents' accounts. Furthermore, other types of guarantor consolidated patient statements, such as an enterprise consolidate patient statement, may also be provided. For example, a healthcare provider may own and/or be associated with different types of healthcare enterprises, including hospitals, physician groups, medical groups, healthcare laboratories, dental practices, and/or the like. To this end, an enterprise consolidated patient statement may include balances due, for the guarantor and his/her dependents, from respective enterprises at which healthcare services have been rendered.

Additionally, a guarantor consolidated patient statement may include a remittance coupon that a patient may use to remit payment on the balance due (e.g., by check, credit card, and/or any other form of payment). The remittance coupon may be sent to a remittance processor (e.g., a bank, and/or private remittance companies) hired by the healthcare provider to handle its remittance processing. The remittance coupon may include information (e.g., the remittance coupon may display optical character recognition scan line data, such as a barcode, etc.) that identifies the guarantor's account. However, the remittance coupon may not include information that identifies each and every medical account associated with the guarantor's dependents. To this end, upon receipt of the remittance coupon, the remittance processor may generate a guarantor payment posting transaction that includes a guarantor identifier but does not include any information identifying the individual accounts of the guarantor. The remittance processor may then transmit the guarantor payment posting transaction to healthcare provider computer of the healthcare provider.

However, the healthcare provider computer may be configured to process payment posting transactions according to individual accounts of a guarantor rather than according to the guarantor identifier. As such, upon receipt of the guarantor payment posting transaction, a user of the healthcare provider computer may manually read the guarantor payment posting transaction and input payment posting information individually for each respective account of the guarantor, which can be a time-consuming and costly process.

### BRIEF DESCRIPTION OF THE DRAWINGS

Reference will now be made to the accompanying drawings, which are not necessarily drawn to scale, and wherein:

FIG. 1 illustrates an example overview of a system that facilitates allocating payments across multiple healthcare accounts as part of the processing of a healthcare payment transaction according to one exemplary embodiment.

FIG. 2A is a diagram of an example data flow for facilitating the allocation of payments across multiple healthcare accounts as part of the processing of a healthcare payment transaction processed through a service provider according to one exemplary embodiment.

FIG. 2B is a diagram of another example data flow for allocating payments across multiple healthcare accounts as part of the processing of a healthcare payment transaction processed through one or more service providers according to an alternative exemplary embodiment.

FIG. 3 is a flow chart of an example method for allocating payments across multiple healthcare accounts as part of the processing of a healthcare payment transaction, in accordance with one exemplary embodiment.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods for allocating payments across multiple healthcare accounts. In certain implementations, a healthcare provider may enroll in a consolidated patient statement service with a service provider. As such, a service provider computer associated with the service provider may generate a consolidated patient statement for a patient of the healthcare provider. The service provider computer may also transmit the consolidated patient statement to the healthcare provider, which may in turn transmit and/or otherwise provide the consolidated patient statement to the patient. The consolidated patient statement may include one or more medical accounts associated with a guarantor. For example, the patient statement may include amounts due on the guarantor's medical account as well as amounts due on one or more accounts for one or more dependents of the guarantor (e.g., wife, children, etc.). In addition, the consolidated patient statement may include a remittance coupon, which the patient and/or other responsible party may use to submit payment to a remittance processor, such as a bank and/or other remittance processing company hired by the healthcare provider to handle its remittance processing. The remittance coupon may include an OCR scan line that stores an identifier for the guarantor. In some example embodiments, the guarantor identifier may include an account number of the guarantor's account with the healthcare provider, an account number of the guarantor's account with the remittance processor, a name of the guarantor, and/or any other type of identifier. The guarantor may submit the remittance coupon to the remittance processor, which may generate a guarantor payment posting transaction. The guarantor payment posting transaction may include the guarantor identifier and a total payment amount received for the benefit of the guarantor and any other medical accounts associated with the guarantor.

Once generated, the guarantor payment posting transaction may be transmitted to the service provider at the service provider computer, either directly and/or indirectly through the healthcare provider. The service provider computer, and/or a payment management module in communication with the service provider computer, may extract, retrieve, determine and/or otherwise access the guarantor identifier included in the guarantor payment posting transaction. As such, the service provider computer and/or the payment management module may determine, based at least in part on the guarantor identifier, one or more open medical accounts associated with the guarantor identifier. The service provider computer and/or the payment management module may compare the total payment amount received against respective outstanding balances for each of the associated open medical accounts. Based at least in part on this comparison, the service provider computer and/or the payment management module may generate an account payment posting transaction, which indicates respective portions of the total payment amount that will be applied to each open medical account associated with the guarantor. Furthermore, the service provider computer and/or the payment management module may transmit the account payment posting transaction to the healthcare provider.

System Overview

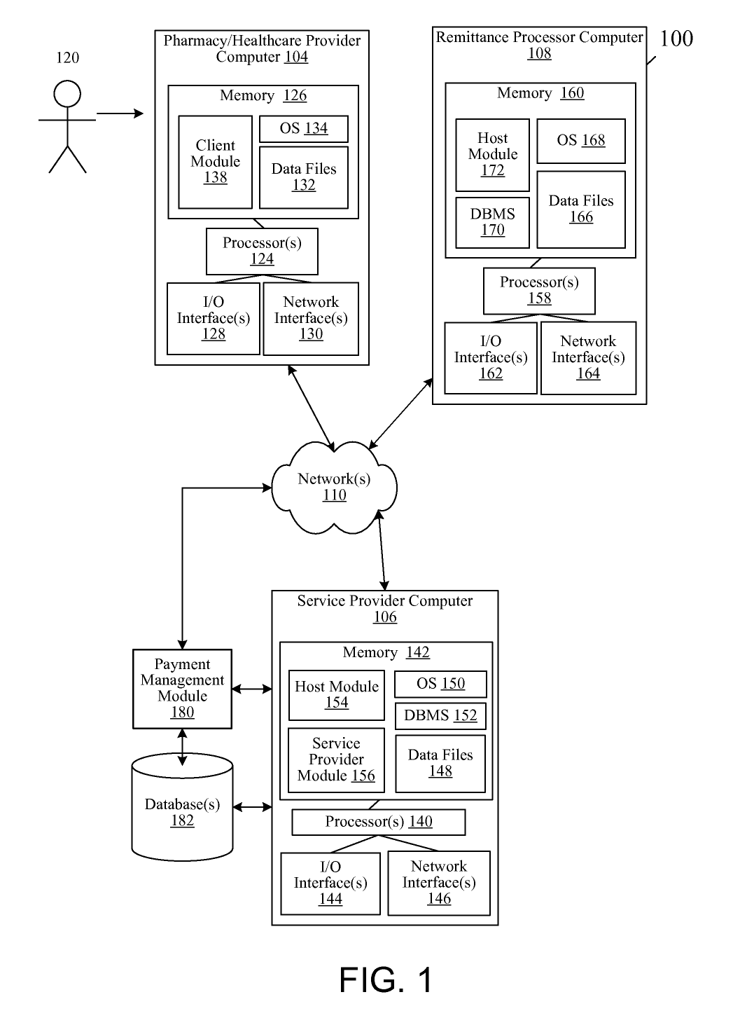

FIG. 1 illustrates an example system 100 supporting healthcare transactions, electronic prescription ordering activities and prescription billing activities according to one example embodiment. The exemplary system 100 facilitates allocating payments across multiple healthcare accounts as part of or in-line with the processing of healthcare payment transactions and will now be described illustratively with respect to FIG. 1. As shown in FIG. 1, the system 100 may include at least one healthcare provider computer 104, at least one service provider computer 106, and at least one remittance processor computer 108. In addition, in certain exemplary embodiments, the system 100 may include a payment management module 180 and a database 182.

As desired, the healthcare provider computer 104, service provider computer 106, payment management module 180, and/or remittance processor computer 108 may include one or more processing devices that may be configured for accessing and reading associated computer-readable media having stored thereon data and/or computer-executable instructions for implementing the various methods disclosed herein. Additionally, in certain exemplary embodiments, the service provider computer 106 and healthcare provider computer 104 may be in communication with one or more payment management modules 180, which may access and/or be in communication with one or more suitable data storage devices, such as database 182. It will be appreciated that the payment management module 180 may be a separate component of the system 100 with its own respective processing capabilities. Alternatively, the payment management module 180, and/or the features and functionality thereof, may be included as part of another component of the system 100, such as the service provider computer 106. The payment management module 180 may receive healthcare payment transactions, such as a guarantor payment posting transaction and/or other billing or payment data from the healthcare provider computer 104, the remittance processor computer 108, and/or the service provider computer 106.

Upon receipt of the healthcare payment transaction (e.g., the guarantor payment posting transaction), the payment management module 180 may determine a guarantor identifier included therein. Based on the identification of the guarantor identifier, the payment management module 180 may determine one or more open medical accounts associated with the guarantor identifier. Information indicating open medical accounts (e.g., account numbers) for respective guarantor identifiers may be stored in the database 182. In addition, the payment management module 180 may be configured to identify any payment allocation rules associated with the healthcare provider for which payment, as represented by the guarantor payment posting transaction, was received. Such payment allocation rules may include situational instructions on how to allocate the money received against each of the open medical accounts associated with the guarantor. For instance, some rules may provide instructions on the respective amounts to allocate to the open medical accounts if the total payment amount exceeds the sum of respective balances of the open medical accounts (e.g., an overpayment). Conversely, some rules may provide instructions on the respective amounts to allocate to the open medical accounts if the total payment amount is less than the sum of the respective balances (e.g., an underpayment). As another example, some rules may provide instructions on the respective amounts to allocate to the open medical accounts if the number of open medical accounts exceeds and/or is fewer than the number of accounts included on the consolidated patient statement.

According to certain example embodiments, the payment management module 180 may generate an account payment posting transaction, which may indicate respective amounts, of the total payment amount, to be allocated to the open medical accounts identified as being associated with the guarantor identifier. As such, the payment management module 180 may be configured to transmit the account payment posting transaction to the healthcare provider computer 104 either directly or via the service provider computer 106.

Generally, network devices and systems, including one or more of the healthcare provider computer 104, service provider computer 106, payment management module 180, and remittance processor computer 108 may include or otherwise be associated with suitable hardware and/or software for transmitting and receiving data and/or computer-executable instructions over one or more communications links or networks. These network devices and systems may also include any number of processors for processing data and executing computer-executable instructions, as well as other internal and peripheral components that are well-known in the art. Further, these network devices and systems may include or be in communication with any number of suitable memory devices operable to store data and/or computer-executable instructions. By executing computer-executable instructions, each of the network devices may form a special purpose computer or particular machine. As used herein, the term “computer-readable medium” describes any form of suitable memory or memory device.

As shown in FIG. 1, the healthcare provider computer 104, service provider computer 106, remittance processor computer 108, and payment management module 180 may be in communication with each other via one or more networks, such as network 110, which as described below can include one or more separate or shared private and public networks, including the Internet or a publicly switched telephone network. Each of these components, the healthcare provider computer 104, service provider computer 106, remittance processor computer 108, payment management module 180, and the network 110 will now be discussed in further detail.

Each healthcare provider computer 104 may be associated with a healthcare provider, such as, for example, a prescriber (such as a doctor, dentist, hospital, physician's office, urgent care center) or pharmacy, etc. Each healthcare provider computer 104 may be any suitable processor-driven device that facilitates the processing of healthcare payment transactions, such as those received from a service provider computer 106. The healthcare provider computer 104 may be a server computer, a mainframe computer, one or more networked computers, a desktop computer, a personal computer, a digital assistant, a personal digital assistant, a digital tablet, an Internet appliance, an application-specific circuit, microcontroller, minicomputer, or any other processor-based device. In certain example embodiments, each healthcare provider computer 104 may be a suitable back office computer associated with a healthcare provider or a group of healthcare providers (e.g. a pharmacy chain, a group of clinics affiliated with a hospital, etc.). The execution of the computer-implemented instructions by the healthcare provider computer 104 may form a special purpose computer or other particular machine that is operable to facilitate the processing of healthcare payment transactions and/or any other information received from a service provider computer 106. Additionally, in certain exemplary embodiments, the operation and/or control of the healthcare provider computer 104 may be distributed amongst several processing components.

In addition to having one or more processors 124, the healthcare provider computer 104 may include one or more memory devices 126, one or more input/output (“I/O”) interfaces 128, and one or more network interfaces 130. The memory devices 126 may be any suitable memory device, for example, caches, read only memory devices, random access memory devices, magnetic storage devices, removable storage devices, etc. The memory devices 126 may store data, executable instructions, and/or various program modules utilized by the healthcare provider computer 104, for example, data files 132, an operating system (“OS”) 134, and/or a client module 138, respectively. The data files 132 may include any suitable data that facilitates the receipt and/or processing of healthcare payment transactions by the healthcare provider computer 104 and the generation and/or processing of healthcare payment transactions that are communicated to the service provider computer 106. For example, the data files 132 may include, but are not limited to, healthcare information (e.g., patient name, patient address, patient gender, patient age, etc.) and/or contact information associated with one or more patients, information associated with the particular healthcare provider and/or the healthcare provider computer 104, information associated with the service provider computer 106, information associated with one or more remittance processor computers 108, information associated with one or more healthcare payment transactions, and/or information associated with one or more guarantors of the healthcare payment transactions.

The OS 134 may be any suitable software module that controls the general operation of the healthcare provider computer 104. The OS 134 may also facilitate the execution of other software modules by the one or more processors 124, for example, the client module 138. The OS 134 may be any currently existing or future developed operating system including, but not limited to, Microsoft Windows®, Apple OSX™, Linux, Unix, or a mainframe operating system.

Each client module 138 may be an Internet browser or other suitable software, including a dedicated program, for interacting with the service provider computer 106 and/or the remittance processor computer 108. For example, a user 120 such as a pharmacist, pharmacy assistant, nurse practitioner, physician, nurse, or other pharmacy, hospital or physician's office employee or any other persons associated with a prescriber, pharmacy, or healthcare provider may utilize the respective client module 138 in providing a healthcare payment transaction, such as a consolidated patient statement, to a patient and/or guarantor of the patient. In addition, the user 120 may also utilize the client module 138 to prepare and/or process certain healthcare payment transactions, such as a guarantor payment posting transaction received from the remittance processor computer 108, for delivery to the service provider computer 106. Furthermore, the user 120 may also utilize the client module 138 to process other types of healthcare payment transactions, such account payment posting transactions, that may be received from the service provider computer 106. The healthcare provider computer 104 may also utilize the respective client module 138 to retrieve or otherwise receive data, messages, or responses from the service provider computer 106 and/or other components of the system 100, as will be described below.

The one or more I/O interfaces 128 may facilitate communication between the components of the system 100 and one or more input/output devices, for example, one or more user interface devices, such as, a display, keypad, control panel, touch screen display, remote control, microphone, etc. that facilitate user interaction with the particular healthcare provider computer 104. For example, the one or more I/O interfaces 128 may facilitate entry of information associated with a healthcare payment transaction by an employee 120 of a healthcare provider, such as a pharmacy employee, pharmacist, physician, nurse, hospital employee, or nurse practitioner affiliated with a pharmacy, hospital, physician's office or other similar healthcare provider. The one or more network interfaces 130 may facilitate connection of the particular healthcare provider computer 104 to one or more suitable networks, for example, the network 110 illustrated in FIG. 1. In this regard, the healthcare provider computer 104 may receive and/or communicate information to other network components of the system 100, such as the service provider computer 106 and the remittance processor computer 108.

With continued reference to FIG. 1, the service provider computer 106 may include, but is not limited to, any suitable processor-driven device that is configured for receiving, processing, and fulfilling information and/or requests from the healthcare provider computer 104, the payment management module 180, and/or the remittance processor computer 108 relating to healthcare payment transactions, other healthcare transactions and/or other activities. In certain exemplary embodiments, the service provider computer 106 may be a switch/router that routes healthcare payment transactions and/or other healthcare requests. For example, the service provider computer 106 may route healthcare payment transactions communicated from the remittance processor computer 108 to the healthcare provider computer 104.

In certain example embodiments, the service provider computer 106 may include a suitable host server, host module, or other software that facilitates the receipt of a healthcare payment transaction, such as a guarantor payment posting transaction, from a remittance processor computer 108. The service provide computer 106 may generate, based at least in part on the guarantor payment posting transaction, an account payment posting transaction and route the account payment posting transaction to the healthcare provider computer 104. The relationship between the guarantor payment posting transactions and account payment posting transactions will be described in more detail below. Furthermore, any number of healthcare provider computers 104, payment management modules 180, and/or remittance processor computers 108 may be in communication with the service provider computer 106, as desired in various embodiments.

The service provider computer 106 may include any number of special purpose computers or other particular machines, application-specific circuits, microcontrollers, personal computers, minicomputers, mainframe computers, servers, networked computers, and/or other processor-driven devices. In certain example embodiments, the operations of the service provider computer 106 may be controlled by computer-executed or computer-implemented instructions that are executed by one or more processors associated with the service provider computer 106 to form a special purpose computer or other particular machine that is operable to facilitate the receipt, routing, and/or processing of healthcare payment transactions. The one or more processors that control the operations of the service provider computer 106 may be incorporated into the service provider computer 106 and/or in communication with the service provider computer 106 via one or more suitable networks. In certain exemplary embodiments, the operation and/or control of the service provider computer 106 may be distributed amongst several processing components.

Similar to the healthcare provider computer 104 described above, the service provider computer 106 may include one or more processors 140, one or more memory devices 142, one or more input/output (“I/O”) interfaces 144, and one or more network interfaces 146. The one or more memory devices 142 may be any suitable memory devices, for example, caches, read only memory devices, random access memory devices, magnetic storage devices, removable memory devices, etc. The one or more memory devices 142 may store data, executable instructions, and/or various program modules utilized by the service provider 106, for example, data files 148, an operating system (“OS”) 150, the host module 154, a service provider module 156, and a database management system (“DBMS”) 152 to facilitate management of data files 148 and other data stored in the memory devices 142.

The OS 150 may be any currently existing or future developed operating system including, but not limited to, Microsoft Windows®, Apple OSX™, Linux, Unix, or a mainframe operating system. The OS 150 may be a suitable software module that controls the general operation of the service provider computer 106 and/or that facilitates the execution of other software modules. According to one exemplary embodiment, the data files 148 may store patient and/or guarantor account information, guarantor identifiers, payment allocation rules, information related to patient billing statements including consolidated patient statements, and/or the like.

The service provider module 156 may be operable to perform one or more pre-edits or pre-analysis, including, but not limited to, analyzing guarantor payment posting transactions prior to routing or otherwise communicating the received healthcare payment transaction to a healthcare provider computer 104. In addition, the service provider module 156 may be operable to perform one or more post-edits or post-analysis related to generating and/or transmitting account payment posting transactions subsequent to evaluation of the guarantor payment posting transactions. A wide variety of different pre-edits and/or post-edits may be performed as desired in various embodiments of the disclosure.

The host module 154 may receive, process, and respond to requests from the client module 138 of one of the healthcare provider computers 104, and may further receive, process, and respond to requests of the host module 172 of the remittance processor computer 108. The service provider computer 106 may include additional program modules for performing other processing methods described herein. Those of ordinary skill in the art will appreciate that the service provider computer 106 may include alternate and/or additional components, hardware or software without departing from exemplary embodiments of the invention.

With continued reference to the service provider computer 106, the one or more I/O interfaces 144 may facilitate communication between the service provider computer 106 and one or more input/output devices, for example, one or more user interface devices, such as a display, keypad, control panel, touch screen display, remote control, microphone, etc. that facilitate user interaction with the service provider computer 106. The one or more network interfaces 146 may facilitate connection of the service provider computer 106 to one or more suitable networks, for example, the network 110 illustrated in FIG. 1. In this regard, the service provider computer 106 may communicate with other components of the system 100.

In certain embodiments, the payment management module 180 of FIG. 1 may be included as part of the service provider computer 106. Alternatively, the payment management module 180 may represent one or more repositories or computers that can be remotely distributed in different geographic locations. Each payment management module 180 may include computer-executable instructions for receiving, processing, and/or otherwise facilitating the management of healthcare payment transactions.

As desired, the payment management module 180 may include any number of special purpose computers or other particular machines, application-specific circuits, microcontrollers, personal computers, minicomputers, mainframe computers, servers, and the like. In certain exemplary embodiments, the operations of the payment management module 180 may be controlled by computer-executed or computer-implemented instructions that are executed by one or more processors associated with each particular payment management module 180 to form a special purpose computer or other particular machine that is operable to facilitate the receipt, processing, and/or storage of patient healthcare payment transaction information and data received from the remittance processor computer 108, the healthcare provider computer 104, and/or the service provider computer 106. The one or more processors that control the operations of each particular payment management module 180 may be incorporated into the payment management module 180 and/or in communication with the payment management module 180 via one or more suitable networks, such as network 110. In certain example embodiments, the operations and/or control of each particular payment management module 180 may be distributed amongst several processing components.

Similar to other components of the system 100, each payment management module 180 may include one or more processors, one or more memory devices, one or more I/O interfaces, and one or more network interfaces. The one or more memory devices may be any suitable memory devices, for example, caches, read only memory devices, random access memory devices, magnetic storage devices, removable memory devices. The one or more memory devices may store data, executable instructions, and/or various program modules utilized by the payment management module 180, for example, data files, an OS, a DBMS, and a host module. The data files may include any suitable information that is utilized by each particular payment management module 180 to receive, process, analyze, and/or store healthcare payment transaction data and payment allocation rules.

The OS 168 may be a suitable software module that controls the general operation of the particular payment management module 180. The OS may also facilitate the execution of other software modules by the one or more processors, for example, the DBMS and/or the host module. The OS may be any currently existing or future developed operating system including, but not limited to, Microsoft Windows®, Apple OSX™, Linux, Unix, or a mainframe operating system. The DBMS may be a suitable software module that facilitates access and management of one or more databases, such as database 182, that are utilized to store information that is received by or utilized by the payment management module 180. The host module may initiate, receive, process, analyze, store, and/or respond to requests, such as the receipt of healthcare payment transactions. The payment management module 180 may include additional program modules as desired. Those of ordinary skill in the art will appreciate that the payment management module 180 may include alternate and/or additional components, hardware or software without departing from example embodiments disclosed herein.

With continued reference to the payment management module 180, the one or more I/O interfaces may facilitate communication between the payment management module 180 and one or more input/output devices, for example, one or more user interface devices, such as a display, keypad, control panel, touch screen display, remote control, microphone, etc. that facilitate user interaction with the payment management module 180. The one or more network interfaces may facilitate connection of each particular payment management module 180 to one or more suitable networks, for example, the network 110 illustrated in FIG. 1. In this regard, the payment management module 180 may receive healthcare payment transactions and data and/or other communications from the healthcare provider computer 104B, the remittance processor computer 108, and/or service provider computer 106.

The database(s) 182 may be operable to store information associated with various healthcare payment transactions, including, but not limited to, guarantor payment posting transactions, account payment posting transactions, consolidated patient statements, patient and/or guarantor account information, payment amounts, guarantor identifiers, payment allocation rules, and/or the like. The healthcare payment transaction information and data in the database 182 may then be accessed and evaluated by the payment management module 180 and/or the service provider computer 106.

With continued reference to FIG. 1, the remittance processor computer 108 may be any suitable processor-driven device that facilitates receiving, processing, and/or fulfilling healthcare payment transactions, such as remittance coupons of consolidated patient statements received from a patient or other guarantor. For example, the remittance processor computer 108 may be a processor-driven device associated with a bank, another financial institution, and/or a remittance processing company. As desired, the remittance processor computer 108 may include any number of special purpose computers or other particular machines, application-specific circuits, microcontrollers, personal computers, minicomputers, mainframe computers, servers, and the like.

In certain exemplary embodiments, the operations of the remittance processor computer 108 may be controlled by computer-executed or computer-implemented instructions that are executed by one or more processors associated with the remittance processor computer 108 to form a special purpose computer or other particular machine that is operable to facilitate the receipt, processing, and/or fulfillment of healthcare payment transactions received from the service provider computer 106, healthcare provider 104, and/or a patient or other guarantor. The one or more processors that control the operations of the remittance processor computer 108 may be incorporated into the remittance processor computer 108 and/or in communication with the remittance processor computer 108 via one or more suitable networks. In certain example embodiments, the operation and/or control of the remittance processor computer 108 may be distributed amongst several processing components.

Similar to other components of the system 100, the remittance processor computer 108 may include one or more processors 158, one or more memory devices 160, one or more input/output (“I/O”) interfaces 162, and one or more network interfaces 164. The one or more memory devices 160 may be any suitable memory devices, for example, caches, read only memory devices, random access memory devices, magnetic storage devices, and removable memory devices. The one or more memory devices 160 may store data, executable instructions, and/or various program modules utilized by the remittance processor computer 108, for example, data files 166, an operating system (“OS”) 168, a database management system (“DBMS”) 170, and a host module 172. The data files 166 may include any suitable information that is utilized by the remittance processor computer 108 to process healthcare payment transactions, for example, guarantor identifiers, guarantor account information, patient profiles, patient insurance information, other information associated with a patient, information associated with a healthcare provider, etc.

The OS 168 may be a suitable software module that controls the general operation of the remittance processor computer 108. The OS 168 may also facilitate the execution of other software modules by the one or more processors 158, for example, the DBMS 170 and/or the host module 172. The OS 168 may be any currently existing or future developed operating system including, but not limited to, Microsoft Windows®, Apple OSX™, Linux, Unix, or a mainframe operating system.

The DBMS 170 may be a suitable software module that facilitates access and management of one or more databases that are utilized to store information that is utilized by the remittance processor computer 108 in various exemplary embodiments. The host module 172 may initiate, receive, process, and/or respond to requests, such as healthcare payment transactions, from the host module 154 of the service provider 106. The remittance processor computer 108 may include additional program modules for performing other pre-processing or post-processing methods described herein. Those of ordinary skill in the art will appreciate that the remittance processor computer 108 may include alternate and/or additional components, hardware or software without departing from the example embodiments described herein.

With continued reference to the remittance processor computer 108 of FIG. 1, the one or more I/O interfaces 162 may facilitate communication between the remittance processor computer 108 and one or more input/output devices, for example, one or more user interface devices, such as a display, keypad, control panel, touch screen display, remote control, microphone, etc. that facilitate user interaction with the remittance processor computer 108. The one or more network interfaces 164 may facilitate connection of the remittance processor computer 108 to one or more suitable networks, for example, the network 110. In this regard, the remittance processor computer 108 may receive healthcare transactions and/or other communications from the service provider computer 106 and the remittance processor computer 108 may communicate information associated with processing the healthcare payment transactions to the service provider computer 106.

The network 110 may include any telecommunication and/or data network, whether public, private, or a combination thereof, including a local area network, a wide area network, an intranet, the Internet, intermediate hand-held data transfer devices, and/or any combination thereof and may be wired and/or wireless. The network 110 may also allow for real-time, off-line, and/or batch transactions to be transmitted between or among the healthcare provider computer 104, the service provider computer 106, the payment management module 180, and/or the remittance processor computer 108. Due to network connectivity, various methodologies, as described herein may be practiced in the context of distributed computing environments. Although the service provider computer 106 is shown for simplicity as being in communication with the healthcare provider computer 104, the payment management module 180, and/or the remittance processor computer 108 via one intervening network 110, it is to be understood that any other network configuration is possible. For example, intervening network 110 may include a plurality of networks, each with devices such as gateways and routers for providing connectivity between or among networks 110. Instead of or in addition to a network 110, dedicated communication links may be used to connect the various devices in accordance with an example embodiment. For example, the service provider computer 106 may form the basis of network 110 that interconnects one or more of the healthcare provider computer 104, the payment management module 180, and the remittance processor computer 108.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. For example, in one exemplary embodiment, the service provider computer 106 (or other computer) may be implemented as a specialized processing machine that includes hardware and/or software for performing the methods described herein. In addition, at least a portion of the processor and/or processing capabilities of the service provider computer 106 may be implemented as part of the remittance processor computer 108. Accordingly, the exemplary embodiments described herein should not be construed as being limited to any particular operating environment, system architecture, or device configuration.

Operational Overview

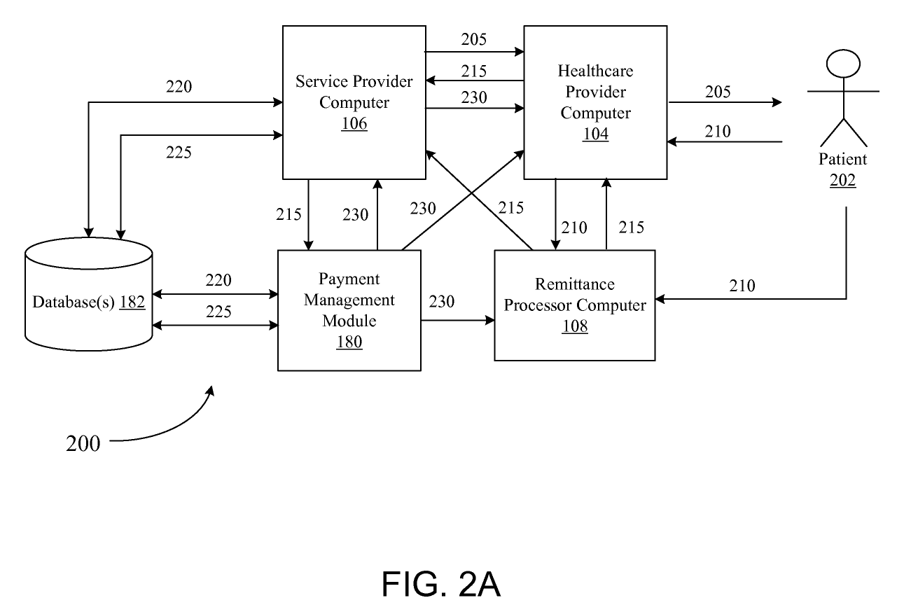

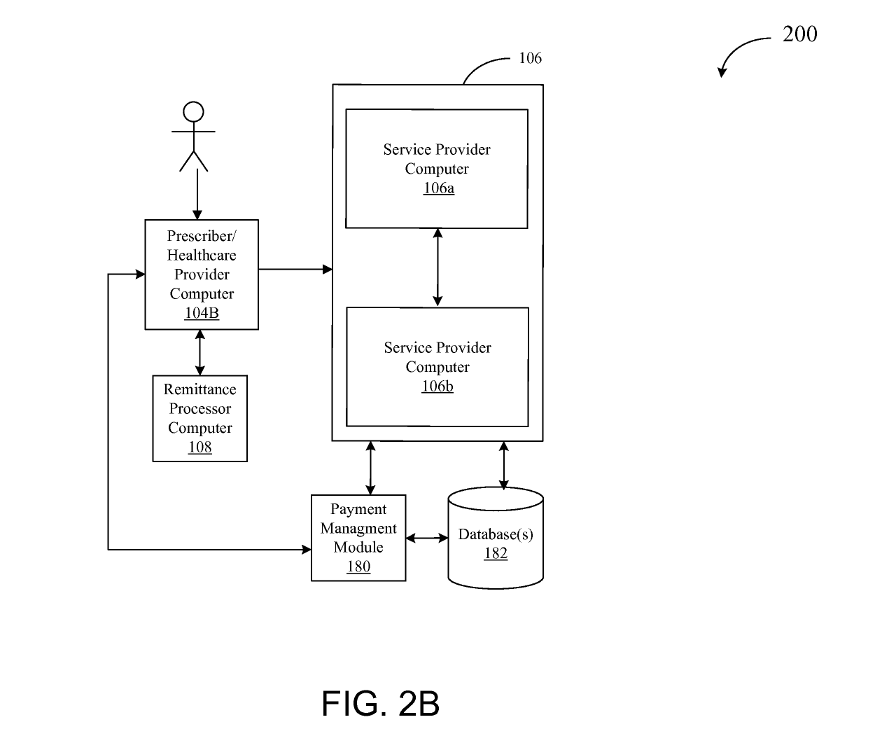

FIG. 2A is a diagram of one example data flow 200 for allocating payments across multiple healthcare accounts as part of or in-line with the processing of a healthcare payment transaction through a service provider, such as through the service provider computer 106 illustrated in FIG. 1. With reference to FIGS. 1 and 2A, a healthcare provider associated with the healthcare provider computer 104 may enroll in a consolidated patient statements service of a service provider associated with the service provider computer 106. For example, the healthcare provider, such as a pharmacy or other healthcare provider, can enroll, be enrolled, or be selected for participation in the healthcare payment transaction program, either with or without their direct knowledge and on either a fee-based or free basis. To this end, the service provider computer 106 may be configured to generate, prepare, transmit and/or otherwise provide a consolidated patient statement 205, to the healthcare provider computer 104, for a patient 202 of the healthcare provider. The consolidated patient statement 205 may include a statement of an open medical account associated with the patient 202 for services rendered by the healthcare provider. As previously discussed, the consolidated patient statement 205 may be a single statement that includes information about the medical account(s) of an insurance guarantor and/or his/her dependents. The consolidated patient statement 205 may indicate a total balance due for the insurance guarantor and/or any individual balances due for respective open medical accounts associated with the guarantor. As such, the patient 202 may be the guarantor, or alternatively, the patient 202 may be any of the guarantor's dependents.

In addition, the consolidated patient statement 205 may include a remittance coupon 210 to facilitate payment of any balance(s) due on the included healthcare account(s). The remittance coupon 210 may be transmitted by the patient 202 and/or guarantor to the remittance processor computer 108 of a bank and/or any other remittance processing companies or financial institutions used by the healthcare provider. The remittance coupon 210 may be directly transmitted to the remittance processor computer 108, or alternatively, may be indirectly transmitted to the healthcare provider computer 104 and then to the remittance processor computer 108. Furthermore, the remittance coupon 210 may include certain information indicating the identity of the guarantor for which payment is being remitted. For example, the remittance coupon 210 may include OCR data (e.g., an OCR scan line such as a barcode or QR code) which may store an identifier of the guarantor (e.g., an account number associated with the guarantor). In certain example embodiments, the OCR data may only have capacity to store the guarantor identifier and may not have capacity to store other information (e.g., account numbers associated with the guarantor's dependents and/or the like) identifying any of the individual medical accounts included in the consolidated patient statement 205. In addition, the remittance coupon 210 may also include the total payment amount (e.g., filled in by the patient 202) representing the amount of money that the patient is submitting to the remittance processor computer 108 for payment.

Upon receipt of the remittance coupon 210, the remittance processor computer 108 may be configured to generate a guarantor payment posting transaction 215. As such, the remittance processor computer 108 may extract, from the consolidate patient statement 205, the guarantor identifier and the total payment amount to be applied to the total balance due by the guarantor, and include such information within the guarantor payment posting transaction 215. In certain example embodiments, the remittance processor computer 108 may also store an identifier for itself (e.g., a processor control number (PCN)) in the guarantor payment posting transaction 215. However, the guarantor payment posting transaction 215 may not indicate nor identify the individual medical accounts associated with the guarantor and/or the guarantor's dependents. Moreover, the guarantor payment posting transaction 215 may not indicate respective amounts of the total payment amount to be allocated to the individual medical accounts. This may be because the remittance coupon 210 may include only the guarantor identifier and may not include any identifiers (e.g., account numbers) associated with the medical accounts included in the consolidated patient statement 205. Additionally, once the guarantor payment posting transaction 215 has been generated, the remittance processor computer 108 may directly transmit the guarantor payment posting transaction 215 to the service provider computer 106, and/or the payment management module 180. Alternatively, the guarantor payment posting transaction 215 may be transmitted indirectly through the healthcare provider computer 104, which may forward the transaction 215 to the service provider computer 106 and/or the payment management module 180. For example, the guarantor payment posting transaction 215 may include a data field to store routing information (e.g., a PCN or any other type of identifier) that indicates the guarantor payment posting transaction 215 should be routed to the service provider computer 106 and/or the payment management module 180.

According to one or more example embodiments, upon receipt of the guarantor payment posting transaction 215, the service provider computer 106 and/or the payment management module 180 may be configured to extract, identify, and/or otherwise determine the guarantor identifier and the total payment amount from the guarantor payment posting transaction 215. For example, the guarantor identifier and the total payment amount may be stored in certain fields of the guarantor payment posting transaction, and the service provider computer 106 may be configured to access and/or extract the data from those fields. To this end, the service provider computer 106 and/or the payment management module 180 may be configured to search, retrieve, receive, and/or otherwise access the database(s) 182 to determine any open medical accounts 220, and their respective balances, associated with the guarantor identifier. For example, the database(s) 182 may store one or more associations between the guarantor identifier and any open medical accounts 220 of the guarantor and/or the guarantor's dependents. Furthermore, the database(s) 182 may also store data indicating respective balances on the open medical accounts 220.

According to certain example embodiments, the database(s) 182 may also be configured to store one or more payment allocation rules 225 for the healthcare provider of the healthcare provider computer 104. The payment allocation rules 225 may provide situational instructions on respective amounts, of the total payment amount included in the guarantor payment posting transaction 215, to be allocated to each of the open medical accounts 220. For instance, some payment allocation rules 225 may provide instructions on particular amounts to allocate to the open medical accounts if the total payment amount exceeds the sum of respective balances of the open medical accounts (e.g., an overpayment). Conversely, some payment allocation rules 225 may provide instructions on particular amounts to allocate to the open medical accounts 220 if the total payment amount is less than the sum of the respective balances (e.g., an underpayment). For example, an underpayment rule may designate an order in which the open medical accounts are to be paid.

As another example, some payment allocation rules 225 may provide instructions on the respective amounts to allocate to the open medical accounts 220 if the number of open medical accounts 220 stored in the database(s) 182 is different (e.g., exceeds and/or is fewer) than the number of accounts included on the consolidated patient statement 205. For example, during a period between the patient receiving the consolidated patient statement 205, and the service provider computer 106 and/or the payment management module 180 receiving the guarantor payment posting transaction 215, more open medical accounts 220 and/or claims may have be opened for and/or associated with the guarantor identifier than what initially appeared on the consolidated patient statement 205. To this end, certain payment allocation rules 225 may determine the respective amounts, of the total payment amount, to be applied to each open medical account 220. For instance, one payment allocation rule 225 may provide instructions for the oldest open medical account 220 to be paid first. Alternatively, the payment allocation rule 225 may provide instructions to distribute the total payment amount equally among all of the open medical accounts 220. Furthermore, in certain implementations, a user profile may be stored (e.g., in the database 182) for each healthcare provider, and respective payment allocation rules 225 for each healthcare provider may be stored in the user profile. In other example embodiments, a user profile may be stored e.g., in the database 182) for each remittance processor computer 108, and respective payment allocation rules 225 for each remittance processor computer 108 may be stored in the user profile.

Upon determination of the open medical accounts 220 associated with the guarantor identifier (e.g., includes a record that has a guarantor identifier that matches the guarantor identifier in the guarantor payment posting transaction 215), the service provider computer 106 and/or the payment management module 180 may perform a comparison between respective balances of the open medical accounts, and the total payment amount included in the guarantor payment posting transaction 215. To this end, the healthcare provider computer 104 and/or the remittance processor computer 108 may provide periodic updates to the database 182 with respect to the respective balances of the open medical account. In certain exemplary embodiments, the comparison may include determining any payment allocation rules 225 to be applied to the open medical accounts 220. As a result of the comparison, the service provider computer 106 and/or the payment management module 180 may generate an account payment posting transaction 230. The account payment posting transaction 230 may include the guarantor identifier as well as information indicating any open medical accounts 220 (e.g., account numbers) associated with the guarantor identifier. Furthermore, the account payment posting transaction 230 may indicate how respective amounts of the total payment amount, subject to the aforementioned payment allocation rules 225, are to be allocated to the open medical accounts 220.

Upon generation of the account payment posting transaction 230, the service provider computer 106 and/or the payment management module 180 may transmit the account payment posting transaction 230 to the healthcare provider computer 104. In some implementations, the account payment posting transaction 230 may be transmitted in real-time and/or near real-time. For instance, upon generation of the account payment posting transaction 230, the service provider computer 106 and/or the payment management module 180 may be configured to immediately transmit the account payment posting transaction 230 to the healthcare provider computer 104. Alternatively, the service provider computer 106 and/or the payment management module 180 may be configured to transmit the account payment posting transaction 230 at scheduled intervals, such as part of a batch operation. For example, the service provider computer 106 and/or the payment management module 180 may be configured to transmit one or more account payment posting transactions 230 once every twenty-four hours and/or at any other interval(s). Thus, one or more account payment posting transactions 230 may be queued for transmission during periods in between such schedule times. Once a schedule time has been reached, the account payment posting transactions 230 may be transmitted to their appropriate destinations.

In certain exemplary embodiments, the account payment posting transaction 230 may facilitate allocation of payment amounts among multiple healthcare accounts for the healthcare provider computer 104. For example, the account payment posting transaction 230 may enable the health provider computer 104 to automatically process payments for open medical accounts 220 associated with the guarantor, including the guarantor's medical account and/or the medical accounts of the guarantor's dependents. Such automatic processing may be performed in lieu of a user 120 manually instructing the healthcare provider computer 104 to open and/or analyze a payment posting transaction (e.g., the guarantor payment posting transaction 215), determine the individual medical accounts therefrom, and manually input the respective payment amounts to be applied to the individual medical accounts 220.

It will be appreciated that variations of FIG. 2A are also available. As shown by FIG. 2B, the service provider computer 106 may include two or more distinct service provider computers 106a and 106b that are in communication with each other. These distinct service provider computers 106a and 106b may be owned, operated, and or located by the same or distinct and wholly-unrelated companies. The service provider computer 106a may be operative with the healthcare provider computer 104, while the service provider computer 106b may be operative with the remittance processor computer 108, payment management module 180, and/or other third-party entity computers. However, the service provider computer 106b may have a data processing arrangement with the service provider computer 106a. Under the data processing arrangement, the service provider computer 106a may be permitted to utilize or offer services of the service provider computer 106b, including the operations and use of the payment management module 180 and/or the database 182 to facilitate account payment posting transactions, as discussed above with reference to FIG. 2A. Accordingly, the services accessible by the service provider computer 106b, including guarantor identifiers, information related to open medical accounts and their respective balances, and payment allocation rules 225, may be available to the pharmacy/healthcare provider computer 104 via the service provider computers 106a and 106b.

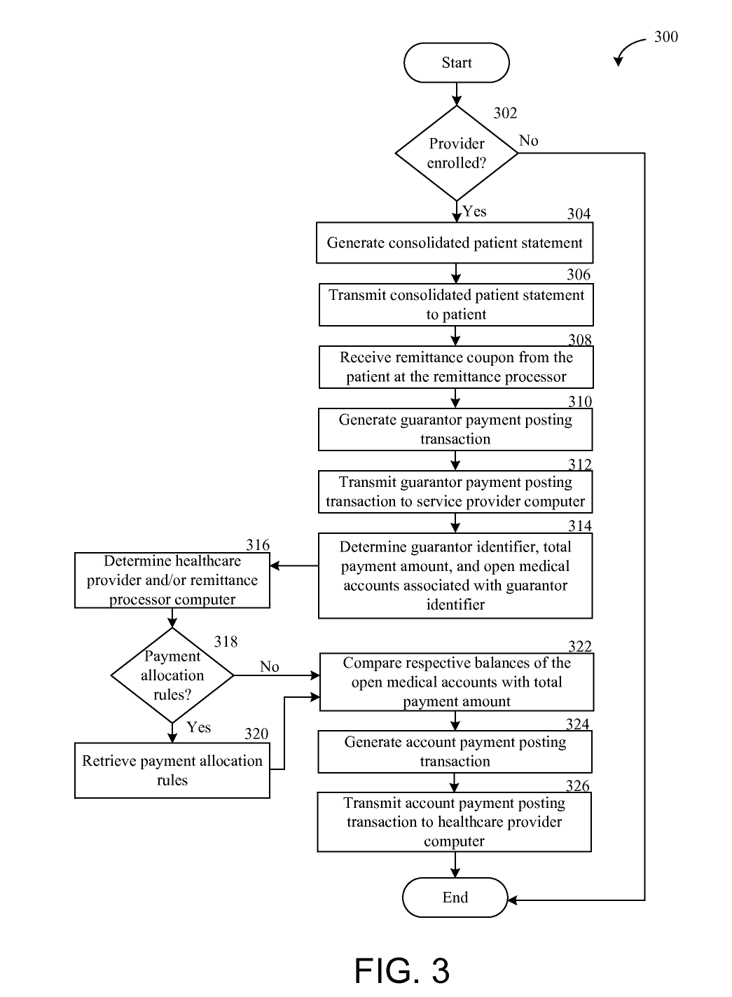

FIG. 3 illustrates a flow chart of an example method 300 for allocating payments across multiple healthcare accounts that is completed as part of the processing of a healthcare payment transaction in accordance with one exemplary embodiment. The exemplary method 300, described below, may be performed by a suitable service provider computer 106 and/or a payment management module 180. The payment management module 180 may be associated with a service provider computer, such as the service provider computer 106 illustrated in FIG. 1. Alternatively, the payment management module 180 may be associated with a third-party computer. Furthermore, the exemplary method 300, described below, will be described with reference to a healthcare provider such as a pharmacy; however, this is only for purposes of example as other healthcare providers could be substituted for, and should each be individually read as being a part of each of these methods. As such, where the discussion of the method 300 below and the drawings state a pharmacy, any other healthcare provider could be substituted, such as a physician, a hospital, physician's office, prescriber of the medication, or healthcare center.

In addition, the exemplary method 300 will be described with reference to a healthcare payment transaction; however, this also is only for purposes of example as other healthcare transactions (which may include, for example, the predetermination of benefits transaction, a healthcare claim transaction, prescription claim or billing request, healthcare order transaction, or e-prescription transaction (i.e., electronic prescription order transaction, e-script, or e-prescription)) could be substituted for the healthcare payment transaction and each form of healthcare transaction should each individually be read as being used in the methods described below.

Referring now to FIGS. 1 and 3, the exemplary method 300 begins at the START step and proceeds to step 302, where an inquiry is made to determine whether the healthcare provider is enrolled in a consolidated patient statement service of the service provider. In one exemplary embodiment, this determination is made by the payment management module 180 and/or the service provider computer 106. For example, an association between an identifier of the healthcare provider (e.g., National Provider Identifier (NPI) or DEA number) and an indication of whether the healthcare provider is enrolled may be stored in the database 182. If payment management module 180 determines that the healthcare provider is not enrolled, the NO branch is followed to the END step and the transaction is processed outside of the method described herein. Otherwise, the YES branch is followed to step 304, where the service provide computer 106 generates a consolidated patient statement on behalf of the healthcare provider for the healthcare claim transaction. For example, the healthcare claim transaction may be for a prescription medication with respect to a healthcare account of a guarantor. To this end, the patient may be the guarantor and/or a dependent of the guarantor. After determining that the healthcare claim transaction has been approved and the medication or services have been provided to the patient, the service provider computer 106 may be configured to generate a consolidated patient statement indicating any balances due for the healthcare account as a result of the provision of the prescription medication or service to the patient. The consolidated patient statement may also include a remittance coupon that may be submitted to a bank and/or a remittance processor computer that may be identified by the healthcare provider at the time of enrollment in the consolidated patient statement service.

In step 306, the consolidated patient statement may be transmitted to the patient (e.g., by mail). As previously discussed, the consolidated patient statement may include a remittance coupon, which the patient may submit to a remittance processor of a bank and/or any other remittance processing company or financial institution to remit payment in response to the consolidated patient statement. In one exemplary embodiment, the remittance coupon may include an identifier for the guarantor of the patient as well as a total payment amount being submitted with the remittance coupon. In an alternative embodiment, the area for the total payment amount in the remittance coupon is a line or box that is initially blank and subsequently filled in by the patient/guarantor with a number representing the amount of payment they are submitting prior to sending the payment and remittance coupon to the remittance processor associated with the remittance processor computer 108.

The remittance processor/remittance processor computer 108 may receive (e.g., via mail, email, in person, and/or any other method of transmission or communication) the remittance coupon from the patient and/or guarantor in step 308. In step 310, the remittance processor computer 108 may evaluate the remittance coupon and based on that evaluation generate a guarantor payment posting transaction, which may include the guarantor identifier and total payment amount submitted by and/or on behalf of the guarantor of the guarantor identifier in the remittance coupon. In one exemplary embodiment, the remittance processor computer 108 parses and/or uses optical character recognition (OCR) on the remittance coupon to determine the guarantor identifier and the total payment amount therein. The remittance processor computer 108 then adds the identified guarantor identifier and total payment amount from the remittance coupon into the guarantor payment posting transaction. The guarantor payment posting transaction may be transmitted by the remittance processor computer 108 to the service provider computer 106 and/or the payment management module 180 in step 312. In one exemplary embodiment, the remittance processor computer 108 directly transmits the guarantor payment posting transaction to the service provider computer 106 and/or the payment management module 180. Alternatively, the guarantor payment posting transaction is initially sent by the remittance processor computer 108 to the healthcare provider computer 104 and then from the healthcare provider computer 104 to the service provider computer 106 and/or the payment management module 180. In this alternative embodiment, the healthcare provider computer 104 may extract routing information (e.g., a PCN or any other type of identifier) from the guarantor payment posting transaction 215 that indicates the service provider computer 106 and/or the payment management module 180 the guarantor payment posting transaction 215 should be routed to.

In step 314, the service provider computer 106 and/or the payment management module 180 may determine the guarantor identifier from the guarantor payment posting transaction. In one exemplary embodiment, the service provider computer 106 and/or the payment management module 180 parses the guarantor payment posting transaction and retrieves the guarantor identifier from a previously known field of the transaction. Based at least in part on the guarantor identifier, the service provider computer 106 and/or the payment management module 180 may determine one or more open medical accounts associated with guarantor identifier. For example, the database 182 may store associations between guarantor identifiers and open medical accounts. Furthermore, the database 182 may be configured to store respective balances of the open medical accounts. Thus, the service provider computer 106 and/or the payment management module 180 may access the database 182, using the guarantor identifier, to identify records that match the guarantor identifier or records tied to or otherwise associated with the guarantor identifier. For those records or fields the service provider computer 106 and/or the payment management module may identify in those records or fields the associated open medical accounts and/or respective balances.

In step 316, the service provider computer 106 and/or the payment management module 180 may determine and/or identify the healthcare provider and/or remittance processor computer 108 associated with the guarantor payment posting transaction. In step 318, the service provider computer 106 and/or the payment management module 180 may determine whether there are any payment allocation rules for the healthcare provider and/or the remittance processor computer 108. If there are no payment allocation rules, the NO path may be followed to step 322. If there are payment allocation rules, the YES path may be followed to step 320, where the payment allocation rules may be retrieved for the healthcare provider and/or the remittance processor computer 108. To this end, the payment allocation rules may also be stored in the database 182 and/or any other storage location, such as in a user profile of the healthcare provider. For example, a user profile of the healthcare provider may store identifier information related to the healthcare provider (e.g., an NPI or Drug Enforcement Agency (DEA) number) as well as any payment allocation rules associated with the healthcare provider.

In step 322, the service provider computer 106 and/or the payment management module 180 may determine the respective balances of the open medical accounts and compare the respective balances with the total payment amount determined from the guarantor payment posting transaction. In certain example embodiments, this comparison may be based on an identified set of payment allocation rules discussed in steps 316-320 that are applied to one or more of the open medical accounts. Furthermore, based at least in part on this comparison and the payment allocation rules, the service provider computer 106 and/or the payment management module 108 may determine respective amounts of the total payment amount to be allocated to each of the open medical accounts. For instance, a guarantor may have three accounts associated with the healthcare provider: account A with a balance of $100, account B with a balance of $75, and account C with a balance of $150. Thus, the total balance of all three accounts may be $325. However, the total payment amount submitted by the guarantor may be $250 which may be less than the $325 owed on the total balance. To this end, certain payment allocation rules may be stored for the healthcare provider that determine the manner in which the total payment amount of $250 should be applied to accounts A, B, and C. For example, the payment allocation rules may indicate that payments should be allocated to the accounts in order of accounts with the largest balance first. Thus, in this example, $150 may be allocated to the account C, $100 may be allocated to account A, and $0 may be allocated to account B. It will be appreciated, however, that various other payment allocation rules for the healthcare provider may also be stored.

In step 324, based at least in part on the comparison, the service provider computer 106 and/or the payment management module 180 may generate an account payment posting transaction. The account payment posting transaction may indicate the guarantor identifier, the open medical accounts associated with the guarantor identifier, and the respective amounts of the total payment amount to be allocated to each of the open medical accounts. In step 326, the service provider computer 106 and/or the payment management module 180 may transmit the account payment posting transaction to the healthcare provider computer 104 via, for example, the network 110. The process may then continue to the END step.

The method described and shown in FIG. 3 may be carried out or performed in any suitable order as desired in various embodiments. Additionally, in certain exemplary embodiments, at least a portion of the operations may be carried out in parallel. Furthermore, in certain exemplary embodiments, less than or more than the operations described in FIG. 3 may be performed.

Accordingly, example embodiments disclosed herein can provide the technical effects of creating a system and method that provides a real-time or near real time way to facilitate account payment posting transactions as part of the processing of a healthcare transaction. In this regard, pharmacies and/or other healthcare providers are able more quickly process payment posting transactions on a per-account basis for a particular guarantor identifier; the healthcare provider may also avoid manually entering information related to the payment posting transactions for each account.

Various block and/or flow diagrams of systems and methods and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, that includes a computer usable medium having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of those set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method, comprising:
receiving, by a service provider computer associated with a service provider from a healthcare provider computer associated with a healthcare provider, a healthcare payment transaction for a patient, wherein the healthcare payment transaction comprises an identifier for a guarantor of the patient and a total payment amount;
determining, by the service provider computer based at least in part on the guarantor identifier, one or more open medical accounts for the guarantor, each of the one or more open medical accounts having a respective outstanding balance;
comparing, by the service provider computer, the total payment amount with the respective outstanding balances for the open medical accounts;
generating, by the service provider computer based at least in part on the comparison, an account payment posting transaction comprising an indication of respective amounts of the total payment amount to be allocated to each of the one or more open medical accounts; and
transmitting, by the service provider computer, the account payment posting transaction to the healthcare provider computer.

2. The computer-implemented method of claim 1, wherein the healthcare payment transaction is a guarantor payment posting transaction.

3. The computer-implemented method of claim 1, wherein the healthcare provider computer comprises at least one of a healthcare provider computer or a remittance processor computer.

4. The computer-implemented method of claim 1, wherein comparing the total payment amount with the respective outstanding balances comprises:
determining, by the service provider computer, whether to apply a set of payment allocation rules to the respective outstanding balances of the one or more open medical accounts; and
allocating, upon negative determination to apply the set of payment allocation rules, the total payment amount to the respective outstanding balances.

5. The computer-implemented method of claim 4, further comprising:
allocating, by the service provider computer and based upon a positive determination to apply the set of payment allocation rules, the respective amounts of the payment, of the total payment amounts, to the respective outstanding balances according to the set of payment allocation rules.

6. The computer-implemented method of claim 1, further comprising:
determining, by the service provider computer, a healthcare provider identifier of the healthcare provider computer;
identifying, by the service provider computer based at least in part on the healthcare provider identifier, a user profile of the healthcare provider; and
determining whether a payment allocation rule exists for the healthcare provider.

7. The computer-implemented method of claim 4, wherein the set of payment allocation rules comprises at least one of a rule for overpayments, a rule for underpayments, a rule for an excess of open medical accounts, or a rule for a shortage of open medical accounts.

8. A system comprising:
at least one processor; and
at least one memory storing computer-executable instructions, that when accessed by the at least one processor, causes the at least one processor to:
receive, from a healthcare provider computer associated with a healthcare provider, a healthcare payment transaction for a patient, wherein the healthcare payment transaction comprises an identifier for a guarantor of the patient and a total payment amount;
determine, based at least in part on the guarantor identifier, one or more open medical accounts for the guarantor, each of the one or more open medical accounts having a respective outstanding balance;
compare the total payment amount with the respective outstanding balances for the open medical accounts;
generate, based at least in part on the comparison, an account payment posting transaction comprising an indication of respective amounts of the total payment amount to be allocated to each of the one or more open medical accounts; and
transmit the account payment posting transaction to the healthcare provider computer associated with the healthcare provider.

9. The system of claim 8, wherein the healthcare payment transaction is a guarantor payment posting transaction.

10. The system of claim 8, wherein the healthcare provider computer comprises at least one of a healthcare provider computer or a remittance processor computer.

11. The system of claim 8, wherein the computer-executable instructions to compare the total payment amount with the respective outstanding balances comprises computer-executable instructions to:
determine whether to apply a set of payment allocation rules to the respective outstanding balances of the one or more open medical accounts; and
allocate, upon negative determination to apply the set of payment allocation rules, the total payment amount to the respective outstanding balances

12. The system of claim 11, wherein the instructions further cause the at least one processor to:
allocate, upon a positive determination to apply the set of payment allocation rules, the respective amounts of the payment, of the total payment amounts, to the respective outstanding balances according to the set of payment allocation rules.

13. The system of claim 11, wherein the set of payment allocation rules is accessed from a database in communication with the service provider computer.

14. The system of claim 11, wherein the set of payment allocation rules comprises at least one of a rule for overpayments, a rule for underpayments, a rule for an excess of open medical accounts, or a rule for a shortage of open medical accounts.

15. A non-transitory computer-readable medium comprising computer-executable instructions, that when executed by at least one processor, causes the at least one processor to:
receive, from a healthcare provider computer associated with a healthcare provider, a healthcare payment transaction for a patient, wherein the healthcare payment transaction comprises an identifier for a guarantor of the patient and a total payment amount;
determine, based at least in part on the guarantor identifier, one or more open medical accounts for the guarantor, each of the one or more open medical accounts having a respective outstanding balance;
compare the total payment amount with the respective outstanding balances for the open medical accounts;
generate, based at least in part on the comparison, an account payment posting transaction comprising an indication of respective amounts of the total payment amount to be allocated to each of the one or more open medical accounts; and
transmit the account payment posting transaction to the computer associated with the healthcare provider.

16. The non-transitory computer-readable medium of claim 15, wherein the healthcare payment transaction is a guarantor payment posting transaction.

17. The non-transitory computer-readable medium of claim 15, wherein the healthcare provider computer comprises at least one of a healthcare provider computer or a remittance processor computer.

18. The non-transitory computer-readable medium of claim 15, wherein the computer-executable instructions to compare the total payment amount with the respective outstanding balances comprises computer-executable instructions to:
determine whether to apply a set of payment allocation rules to the respective outstanding balances of the one or more open medical accounts; and
allocate, upon negative determination to apply the set of payment allocation rules, the total payment amount to the respective outstanding balances

19. The non-transitory computer-readable medium of claim 18, wherein the instructions further cause the at least one processor to:
allocate, upon a positive determination to apply the set of payment allocation rules, the respective amounts of the payment, of the total payment amounts, to the respective outstanding balances according to the set of payment allocation rules.

20. The non-transitory computer-readable medium of claim 18, wherein the set of payment allocation rules comprises at least one of a rule for overpayments, a rule for underpayments, a rule for an excess of open medical accounts, or a rule for a shortage of open medical accounts.
